(19) United States
(12) Patent Application Publication
(10) Pub. No.: US 2010/0044971 A1
(43) Pub. Date: Feb. 25, 2010

(54) APPARATUS FOR A SEALING FITTING ASSEMBLY

(76) Inventor: Drew P. Henry, Oroville, CA (US)

Correspondence Address: Kunzler & McKenzie, 8 EAST BROADWAY, SUITE 600, SALT LAKE CITY, UT, 84111, US

(21) Appl. No.: 12/613,116

(22) Filed: Nov. 5, 2009

Related U.S. Application Data
(63) Continuation-in-part of application No. 11/101,051, filed on Apr. 6, 2005, now Pat. No. 7,325,810.
(60) Provisional application No. 61/111,700, filed on Nov. 5, 2008.

(51) Int. Cl. F16L 5/14

(52) U.S. Cl. 277/606

(57) ABSTRACT

An apparatus is disclosed for a sealing fitting assembly. The apparatus includes a first gasket disposed between a first flange and a wall. The first flange includes a sleeve extending through the first annular gasket, an opening in the wall, a second gasket, and a second flange. The second gasket is disposed between a wall and the second flange. In another embodiment, the apparatus includes a first boot having first and second ends, the first end engaging a tube, and the second end coupling with a boot mounting portion of the first flange. The apparatus also includes a second boot having first and second ends, the first end having an interlocking portion that engages the first end of the first boot, and a second end coupling with the second flange. The second boot has a length selected to enclose the first boot, the first flange, the second flange, and mounting devices.

### CROSS-REFERENCES TO RELATED APPLICATIONS

This is a continuation-in-part application of and claims priority to, U.S. patent application Ser. No. 11/101,051 entitled “TANK CONDUIT ORIFICE SEALING DEVICE WITH INTERNAL BOLTS” and filed on Apr. 6, 2005 for Drew P. Henry, and U.S. Provisional Patent Application Number 61/111.700 entitled “ROLLED FITTING ASSEMBLY” and filed on Nov. 5, 2008 for Drew P. Henry which is incorporated herein by reference.

### BACKGROUND

1. Technical Field

This present disclosure relates to sealing devices for tubes that extend through walls and the mounting devices thereof.

2. Description of the Related Art

Numerous conventional sealing devices exist that provide a manner for sealing a tube that extends through a wall. However, for applications wherein the wall is that of an underground tank, conventional devices fail to provide a boot or sealing device that enables an installer to double seal a conduit or pipe that penetrates the wall, as required by various state and federal regulations. Additionally, conventional boot sealing devices fail to provide the creation of a separate interior environment for encapsulating the mounting hardware for the mounting device and the tube. Further conventional devices fail to provide an attachment means for rock guard conduits that are typically used around the tubes in underground applications.

### SUMMARY

From the foregoing discussion, it should be apparent that a need exists for an apparatus that seals a conduit that passes through a wall. The present disclosure has been developed in response to the present state of the art, and in particular, in response to the problems and needs in the art that have not yet been fully solved by currently available fitting assemblies. Accordingly, the present disclosure has been developed to provide an apparatus that overcomes many or all of the above-discussed shortcomings in the art.

The apparatus, in one embodiment, includes a first annular gasket disposed between a first flange and an outer wall of a double wall. The first annular gasket is formed to engage both the outer wall and the first flange simultaneously. The first flange includes a sleeve extending through the first annular gasket, an opening in the double wall, a second annular gasket, and a second flange. The second annular gasket is disposed between an inner wall of the double wall and the second flange and formed to engage both the inner wall and the second flange.

In one embodiment, the first flange further includes a first boot mounting portion formed to engage a first flexible sealing boot that has a diameter selected to form a seal between the sleeve and a tube extending through the first flange and the second flange. Similarly, the second flange further includes a second boot mounting portion formed to engage a second flexible sealing boot having a diameter selected to form a seal with the tube and enclose the second annular gasket and the second flange. In a further embodiment, the first flexible sealing boot and the second flexible sealing boot each comprise an interlocking portion such that the first flexible sealing boot and the second flexible sealing boot are secured to the tube with a single fastening device.

The apparatus may also include a plurality of mounting devices positioned radially outside of the sleeve that extend through the first and second annular gaskets and into corresponding openings in the second flange. The mounting devices may be threaded rods that extend through the second flange and into a plurality of fasteners. The fasteners, in one embodiment, are nuts having a diameter selected to engage the threaded rods. The first flange may include a collar extending away from the double wall, and a third boot mounting portion. In a further embodiment, the apparatus includes a gravel guard.

The present disclosure also includes a device for sealing a tube that extends through a wall. The device may include a first annular gasket disposed between a first flange and an outer wall of a double wall. The first annular gasket has an inner sealing surface formed to engage the outer wall and an outer sealing surface formed to engage the first flange. The first flange includes a sleeve extending from the first flange and a diameter less than a diameter of the first annular gasket such that the sleeve extends through the first annular gasket and through an opening in the double wall.

The first flange also includes mounting devices extending through the opening and into the second flange. In one embodiment, the sleeve includes a first boot mounting area formed at the distal end of the sleeve. The device also includes a second annular gasket disposed between an inner wall of the double wall and the second flange. The second flange has a collar that extends away from the inner wall and a second boot mounting end formed at the distal end of the collar.

The present disclosure also includes an apparatus for sealing a tube that extends through a wall. The apparatus includes a first flexible sealing boot having first and second ends. The first end has a diameter selected to engage a tube that extends through the first flexible sealing boot, and the second end has a diameter selected to couple with a boot mounting portion of a first flange.

The apparatus also includes a second flexible sealing boot having first and second ends. The first end has an interlocking portion that engages the first end of the first flexible sealing boot, and a second end has a diameter selected to couple with a second flange. The second flexible sealing boot has a length selected to enclose the first flexible sealing boot, the first flange, the second flange, and a plurality of mounting devices extending from the first flange to the second flange.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a perspective view illustration depicting an underground double-walled storage tank;

FIG. 2 is a perspective-view cross-section illustration depicting a rolled sealing fitting for sealing a conduit that passes through a single or double-walled storage tank;

FIG. 3 is an exploded view diagram illustrating one embodiment of the fitting;

FIG. 4 is a perspective view diagram illustrating one embodiment of the first flange;

FIG. 5 is a perspective view diagram illustrating one embodiment of the second flange;

FIG. 6a is a perspective view diagram illustrating one embodiment of the first gasket;

FIG. 6b is a perspective view diagram illustrating one embodiment of the second gasket;

FIG. 7 is a perspective view diagram illustrating one embodiment of the first flexible boot;

FIG. 8 is a perspective view diagram illustrating one embodiment of the second flexible boot;

FIG. 9 is a perspective view diagram illustrating a cross-sectional view of an interlocking area of the first and second boots; and

FIG. 10 is a perspective view diagram illustrating one embodiment of the gravel guard.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

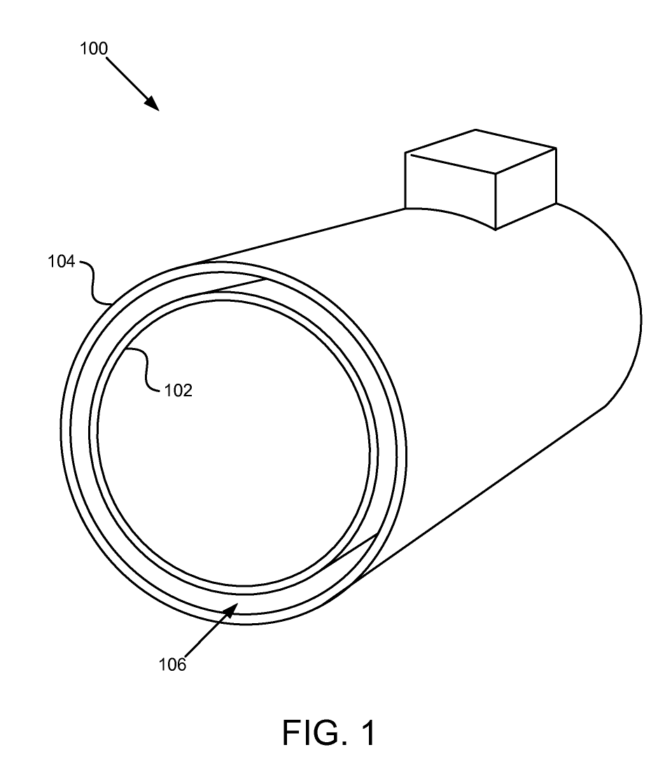

FIG. 1 is a perspective view illustration depicting an underground double-walled storage tank 100. The use of double-walled underground storage tanks for the storage of hazardous liquids is mandated in some states. The underground double-walled storage tank 100, as the name suggests, is essentially an inner tank 102 inside of an outer tank 104. The inner tank 102 contains the hazardous liquid, and the outer tank 104 encloses an interstitial space formed between the inner tank 102 and the outer tank 104. Any leaked liquid is captured in the interstitial space 106 so long as the outer tank 104 also is not breached.

The double-walled underground storage tank 100 is a result of the desire to prevent hazardous liquids from leaking into the surrounding ground. This is accomplished through various leak detection methods known by those of skill in the art. Some of these leak detection methods include dry and wet leak detection systems. Dry systems generally include the placement of sensors in the interstitial space 106 to detect the presence of liquids. Wet systems generally include filling the interstitial space with a liquid or gas and then detecting a change in either pressure or volume. The present disclosure beneficially enables fluid communication between the interstitial space 106 and double-walled conduits that penetrate the underground storage tank 100 as will be disclosed below.

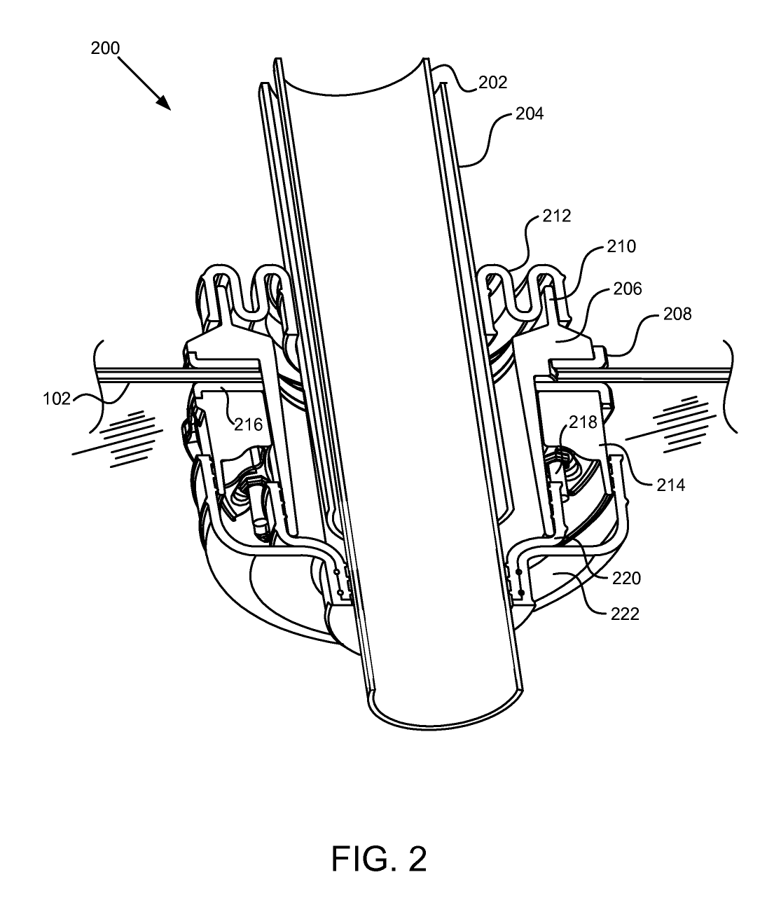

FIG. 2 is a perspective-view cross-section illustration depicting a rolled sealing fitting (hereinafter “fitting”) 200 for sealing a conduit that passes through a single or double-walled storage tank. The fitting 200 is configured for providing a double seal around a conduit or pipe 202 having a diameter selected according to a predetermined application. For example, the pipe 202 may have a diameter selected to efficiently transport fuel. The pipe 202 penetrates through tanks, walls, etc. in an underground environment to transport fuel from the underground storage tank to a gas pump, for example. In the depicted embodiment, the pipe 202 passes through an opening in the double-walled tank 100 of FIG. 1 and is sealed by the fitting 200.

In certain applications, government agencies mandate the use of a double conduit, or in other terms, a pipe 202 inside of a pipe 204. The present disclosure beneficially enables the above described wet leak detection systems to detect a change in pressure or volume in the interstitial area of the inner and outer tanks because the fitting 200 maintains fluid communication between the interstitial area of the tanks and an annular interstitial area between the inner pipe 202 and the outer pipe 204. In one embodiment, the outer pipe 204 will extend only to the outer surface of the outer tank 104. Alternatively, the outer pipe 204 extends partially into the fitting 200 and the inner pipe 202 extends past the fitting 200 and into the inner tank 102, as depicted in FIG. 2.

The fitting 200, when in use, provides a double seal of the pipe 202 or conduit that penetrates through the walls of the inner and outer tanks 102, 104. A first flange 206 is installed on an outer surface of the outer tank 104 along with a first gasket 208 between the first flange 206 and the outer tank 104. The first flange 206 includes a boot mounting area 210, where an external flexible boot 210 may be attached to the first flange 206. The external flexible boot 212, or gravel guard, provides a first seal to the pipe 202 or pipe 204 external to the inner and outer tanks 102, 104 and covers the first flange 206, thereby protecting the first flange 206 from the underground environment.

The fitting 200 is adaptable to pipes 202, 204 of different diameters. As such, although depicted sealing a double-piped 202, 204 configuration, the fitting 200 is likewise capable of sealing a single pipe configuration by selecting the diameter of the gravel guard 212 to engage the pipe.

The fitting 200 also includes a second flange 214 and a second gasket 216. The second flange 214 along with the second gasket 216 are installed on an inner surface of the inner tank 102 with the second gasket 216 against the inner surface. Mounting devices 218, which are formed on the first flange 206, and penetrate the wall, correspond to a plurality of openings (not shown in FIG. 2) on the second flange 214. Fasteners attach to the mounting devices 218 and secure the first and second flanges 206, 214 to the tank wall. In this exemplary embodiment, the mounting devices 218 are threaded rods integral to the first flange 206, and the fasteners are nuts. It should be appreciated that in other various exemplary embodiments, the mounting devices and the fasteners could be of other devices common in the art. Further, it should be appreciated that in other various exemplary embodiments, the threaded rods may be removable from the first flange.

The fitting 200, in one embodiment, also includes a first flexible boot 220 and a second flexible boot 222. The first and second flexible boots 220, 222 together seal the pipe 202 and protect the second flange 214 and the mounting devices 218 from the hostile chemical environment of the underground storage tank. The fitting 200, in one embodiment, beneficially provides an installer the ability of accessing both the flexible boots 220, 222, and the mounting devices 218 from inside the tank. This feature eliminates the need over conventional devices to excavate the dirt around the outside of underground tank in order to gain access to the flexible boots 220, 222. Furthermore, the fitting 200 allows for the installation of flexible sealing boots that encapsulate all mounting hardware and structural components on the inside of the underground tank. This allows a user to service the fitting 200 for the foreseeable future without the need for excavation. If a flexible boot should fail a replacement boot can be installed without the need for replacement of any of the components in the system.

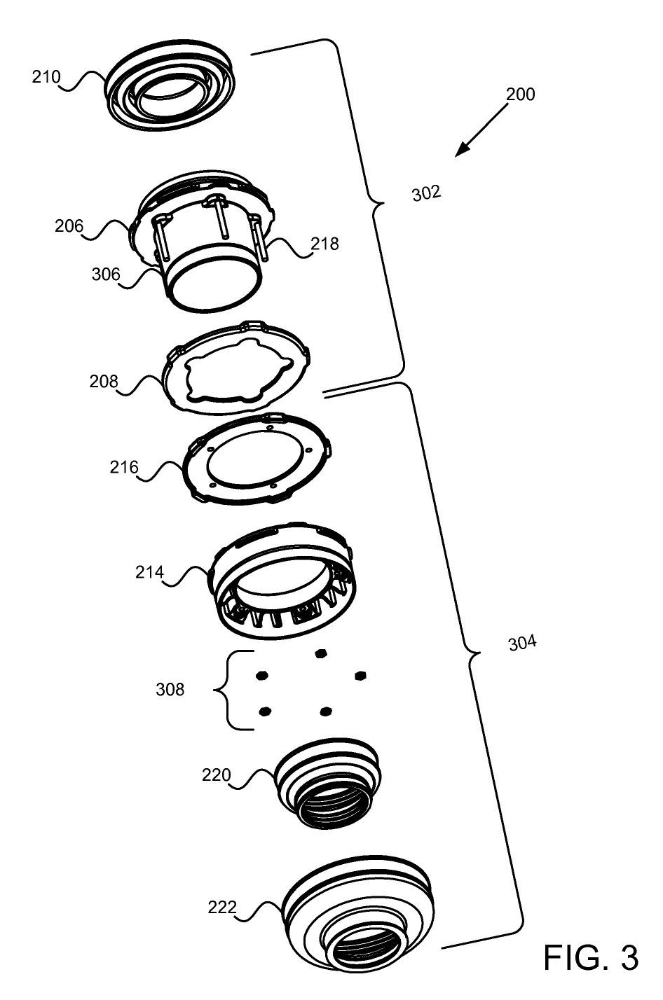

FIG. 3 is an exploded view diagram illustrating one embodiment of the fitting 200. The fitting 200, as described above, is formed of exterior components 302 that are installed on the exterior of the double-walled tank, and interior components 304 that are installed on the interior of the double-walled tank. Alternatively, the fitting 200 is adaptable for use on single-walled tanks and/or double-walled tanks having small or large interstitial areas by modifying the length of the mounting devices 218 and a sleeve 306 that extends from the first flange 206 through the first gasket 208, second gasket 216, and second flange 214.

As mentioned above, the exterior components 302 exist in an underground environment, and therefore, are formed of materials resistant to corrosion in underground environments. In other words, the exterior components 302 are capable of existing in an environment of dirt and gravel. The exterior components include the first flange 206, the first gasket 208, and the gravel guard 210. The gravel guard 210 forms a seal around the pipe (not shown here) to prevent dirt, gravel, etc., and groundwater from entering the underground storage tank.

The interior components 304 include the second flange 214, the second gasket 216, the first flexible boot 220, the second flexible boot 222 and fasteners 308. The internal mounting of hardware and the subsequent enclosure of the hardware by the flexible boots keeps the mounting devices 218 inside the fitting and out of the internal, and possibly hostile, environment of the tank.

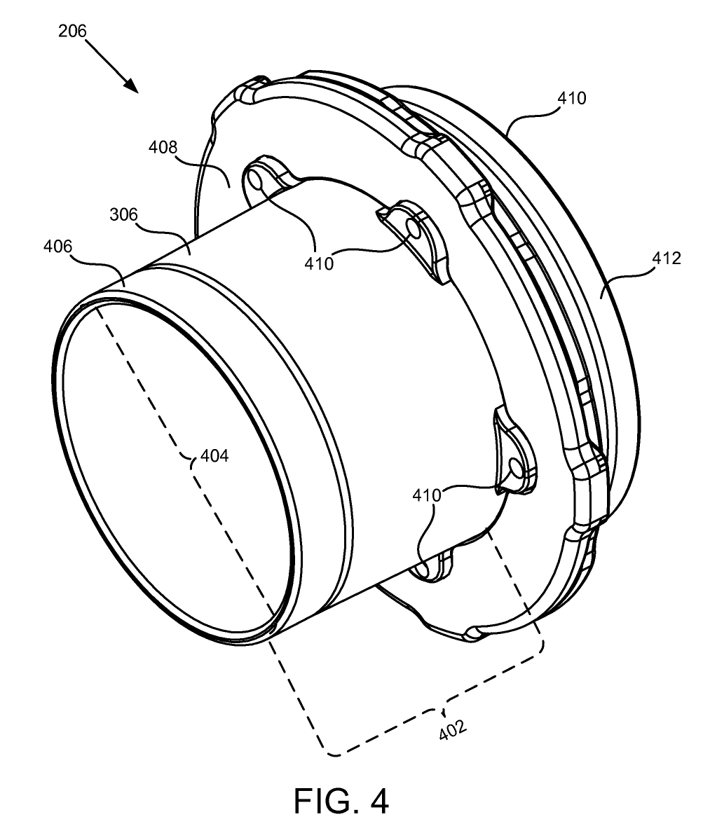

FIG. 4 is a perspective view diagram illustrating one embodiment of the first flange 206. The first flange 206 includes a sleeve 306 that has a length 402 selected to extend through the interstitial area described above with reference to FIG. 1. The length 402 of the sleeve 306 is sufficient to extend through the tank wall and extend beyond the second flange 214, as depicted in FIGS. 2-3. The sleeve 306 has a diameter 404. The diameter 404 of the sleeve 306 is larger than the diameter of the pipe 202 of FIG. 2. At the distal end of the sleeve 306 is a boot mounting area 406. The first flexible boot 220 mounts on the first boot mounting area 406 and provides a second seal to the pipe 202 penetrating the tank wall.

In one embodiment, the length 402 of the sleeve 306 is in the range of between about 2 and 6 inches, and the diameter 404 of the sleeve 306 is in the range of between about 2 and 6 inches. However, it should be appreciated that in other various exemplary embodiments, the values for the length and diameter may be adjusted according to the dimensions of the pipe and interstitial area respectively.

The first flange 206 includes a surface or tank mating portion 408 and a collar 410. The collar 410 and the sleeve 306 extend in opposite directions from the tank mating portion 408, both providing flexible boot mounting areas 406, 412 at their respective distal ends. The tank mating portion 408 mates or seals against the first gasket 208. The tank mating portion 408 also includes openings 410 for receiving the mounting devices 318 as shown in FIG. 3. Alternatively, the mounting devices 318 may be integrally formed and extending outward from the tank mating portion 408.

The first flange 206 and the second flange 214 may be formed of a rigid material. For example, the first flange may be made out of a material that is 30% glass filled nylon. It should be appreciated that the first flange and second flange can be made out of any fuel rated rigid plastic reinforced with glass fill.

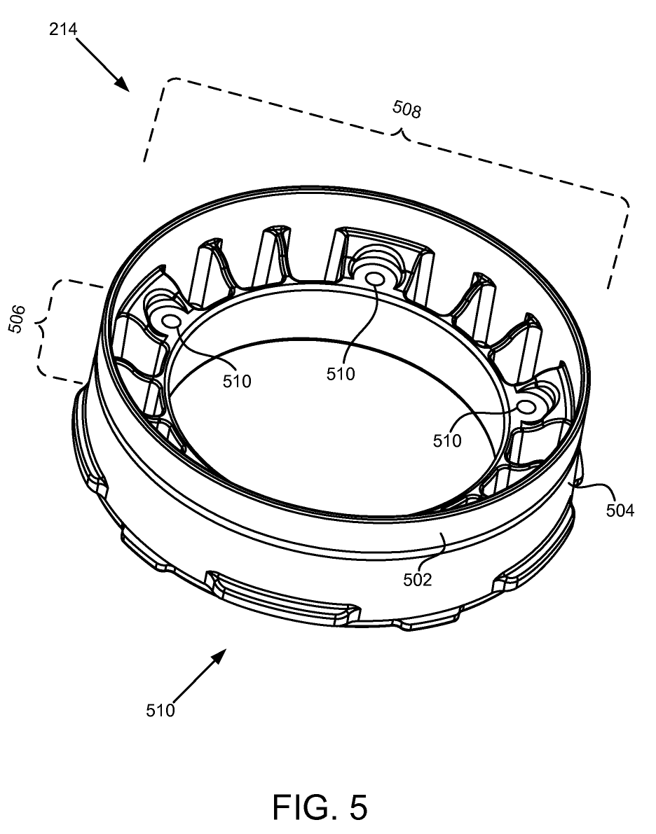

FIG. 5 is a perspective view diagram illustrating one embodiment of the second flange 214. The second flange 214 is operably configured to be disposed around the sleeve 306, or in other words, the sleeve 306 extends through the second flange 214. The second flange 214 includes a second boot mounting area 502 disposed on an external diameter of the collar 504 that extends from the second flange 214.

The second boot mounting area 502 is configured to engage the second flexible boot 222 as illustrated in FIG. 2. The flexible boots 220, 222 may be attached by a fastener to the respective flanges 206, 214 and to the pipe. In one embodiment, a hose or band clamps are used. However, it should be appreciated that in other various exemplary embodiments, other fasteners common in the art may be used.

The second flange 214 further includes a height 506, a diameter 508 and a mating surface 510. The mating surface 510 mates with the second gasket 216 to seal the second flange 214 against the wall of the tank. In one embodiment, the height 506 is in the range between about 1 and 3 inches, and the diameter 508 is in the range of between about 2 and 6 inches. The second flange 214 also includes a plurality of openings 510 for receiving the mounting devices 218 of FIG. 2. The plurality of openings 510 are spaced 72 degrees apart, however, it should be appreciated that in other various exemplary embodiments, the values for the spacing and positioning of the openings 510 may be adjusted according to the particular application.

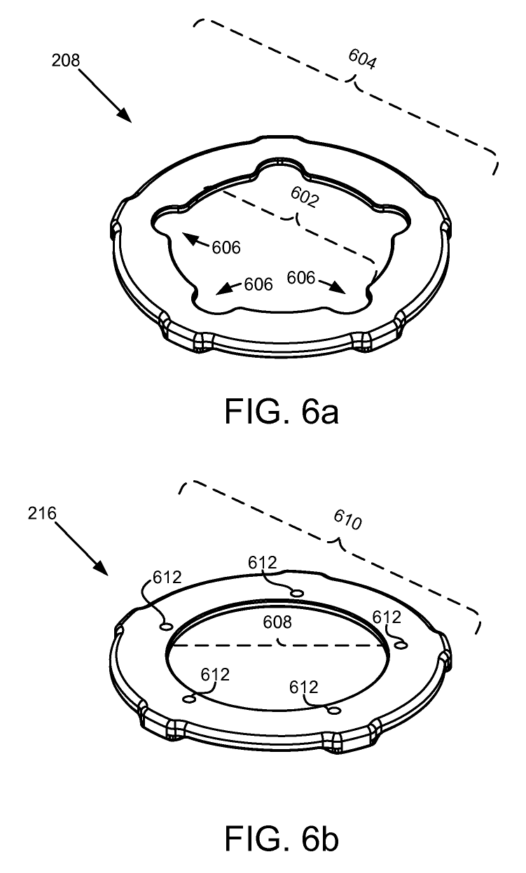

FIG. 6a is a perspective view diagram illustrating one embodiment of the first gasket 208. The first gasket 208 is formed of a flexible fuel-rated material that is resistant to the hostile chemical environment of an underground fuel storage tank. In one embodiment, the material is Pellethane™ available from the Dow Chemical company of Midland, Mich. Alternatively, the first gasket 208 may be constructed from any number of flexible fuel-rated materials common in the art of gaskets.

The first gasket 208 is formed in a generally annular configuration, having an opening with a diameter 602 selected to allow the sleeve 306 of the first flange 206 to pass through the first gasket 208. The first gasket 208 has an outer diameter 604 selected to correspond to an outer diameter of the first flange 206. The first gasket may also be configured with a plurality of cut-out portions 606 that enable the mounting devices 218 of FIGS. 2 and 3 to pass through the first gasket 208. Alternatively, the cut-out portions 606 may be replaced with openings in the first gasket 208 while still enabling the mounting devices 218 to pass through the first gasket 208 and engage the second flange 214.

The depicted embodiment illustrates a generally planar first gasket 208. The generally planar configuration of the first gasket 208 is intended for use on underground storage tanks having planar surfaces, such as underground ground storage tanks having octagonal cross sections. However, the first gasket 208 may be adapted to engage an underground storage tank having a curved surface. In this embodiment, the first gasket 208 is formed having a first curved surface configured to engage the curved surface of the underground storage tank, and a second planar surface to engage the first flange 206.

FIG. 6b is a perspective view diagram illustrating one embodiment of the second gasket 216. The second gasket 216, like the first gasket 208, is formed of a flexible fuel-rated material that is resistant to the hostile chemical environment of an underground fuel storage tank.

The second gasket 216 is formed in a generally annular configuration, having an opening with a diameter 608 selected to allow the sleeve 306 of the first flange 206 to pass through the second gasket 216. The second gasket 216 has an outer diameter 610 selected to correspond to an outer diameter of the second flange 214. The second gasket 216 may also be configured with a plurality of openings 612 that enable the mounting devices 218 of FIGS. 2 and 3 to pass through the second gasket 216. Alternatively, the openings may be replaced with cut-out portions as depicted above with reference to FIG. 6a.

Like the first gasket, the second gasket 216 may also be configured to engage underground storage tanks having planar or curved surfaces. For example, the second gasket 216 may be formed having a first curved surface configured to engage the curved surface of the underground storage tank, and a second planar surface to engage the second flange 214.

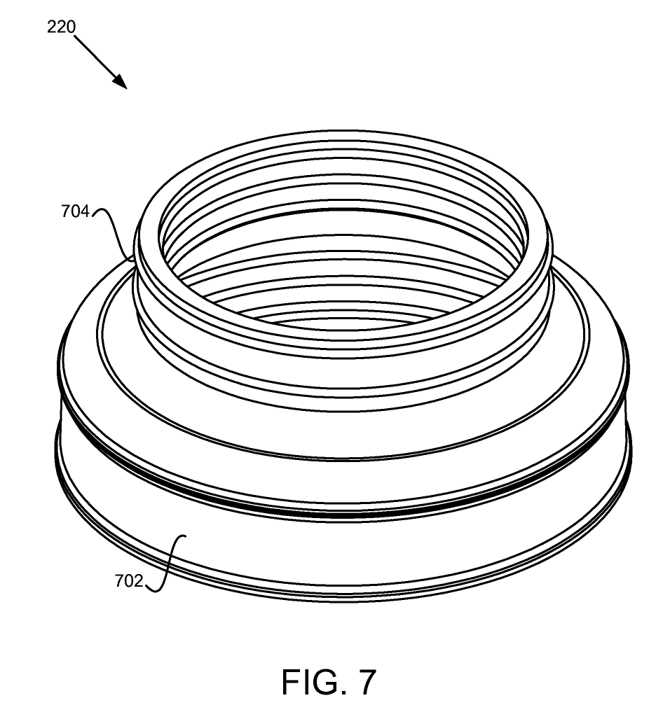

FIG. 7 is a perspective view diagram illustrating one embodiment of the first flexible boot (hereinafter “first boot”) 220. The first boot has a base portion 702 with a first diameter and a neck portion 704 with a second diameter. The base portion 702 is disposed on the sleeve 306 of FIG. 3 and held in place with the band clamp (not shown). The pipe extends through the neck portion 704. The first boot 220, in one embodiment, is formed of a flexible fuel resistant material as described above with reference to the first and second gaskets 208, 216.

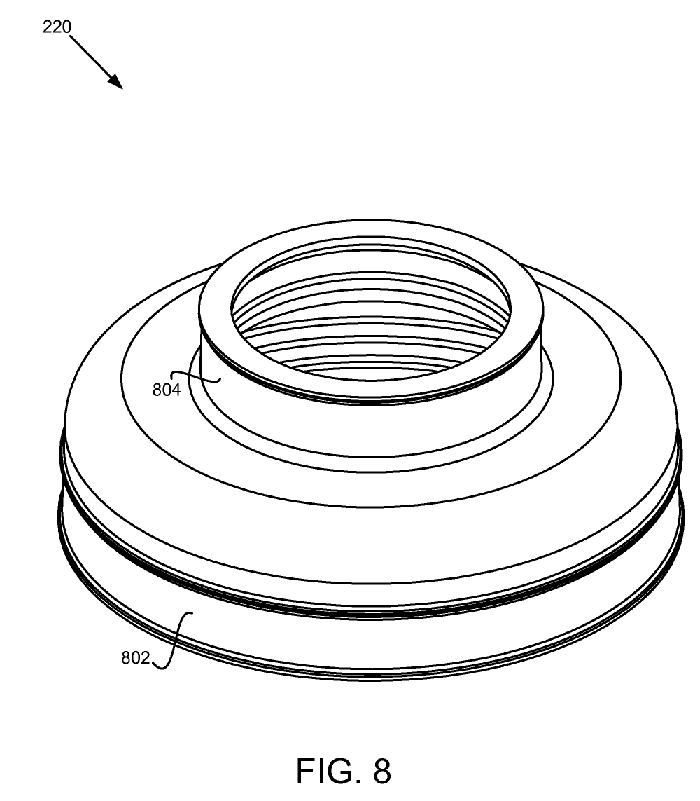

FIG. 8 is a perspective view diagram illustrating one embodiment of the second flexible boot (hereinafter “second boot”) 222. The second boot 222 covers the mounting devices 218 and fasteners 302 that hold the first and second flanges 206 and 214 sealably to the tank wall. The second flange 214 is covered by the second boot 222 and protected from the contents of the tank.

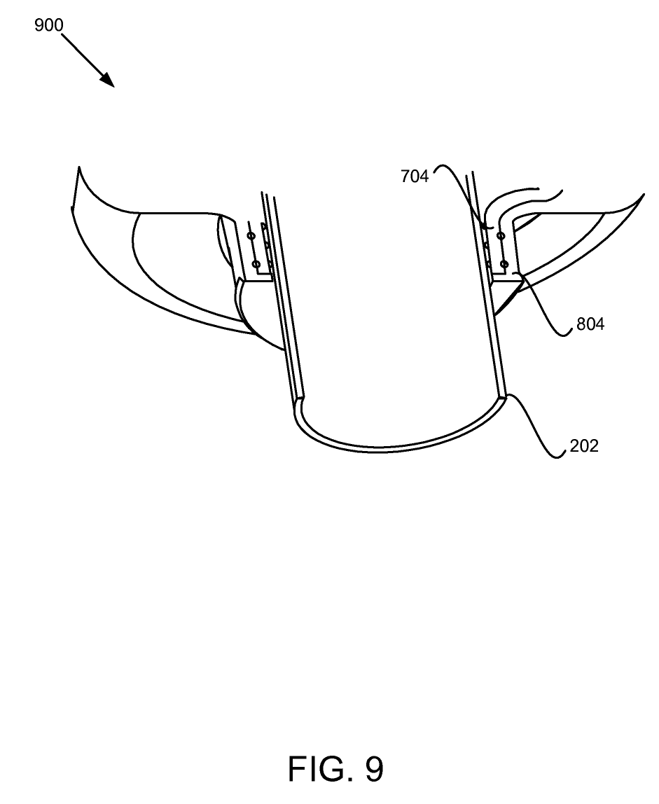

The second boot 222 has a base portion 802 with a first diameter and a neck portion 804 with a second diameter. The base portion 802 is disposed on the second flange 214 and held in place with the band clamp (not shown). As shown in FIG. 2, the neck portion 804 of the second boot 222 is disposed on top of the neck portion 704 of the first boot 220. Another band clamp is used to secure the first and second boots 220, 222 to the pipe creating a seal. This overlapping or interlocking feature will be discussed in greater detail below with reference to FIG. 9.

FIG. 9 is a perspective view diagram illustrating a cross-sectional view of an interlocking area 900 of the first and second boots. In one embodiment, the first boot 220 and the second boot 222 are secured to the pipe 202 with one hose clamp (not shown) by overlapping the neck portions 704, 804 of the first and second boots 220, 222. FIG. 9 omits many details illustrated in FIGS. 2-8 to draw attention to the overlapping and interlocking area of the first and second boots 220, 222.

As illustrated, the neck portion 704 of the first flange 206 has a diameter selected to engage the pipe 202, while the neck portion 804 of the second flange 214 has a diameter selected to engage the neck portion 704 of the first boot 220. This interlocking feature, which connects the boots at the primary pipe clamping surface, allows the installer to use a single compression clamp to clamp both the first and second boots 220, 222.

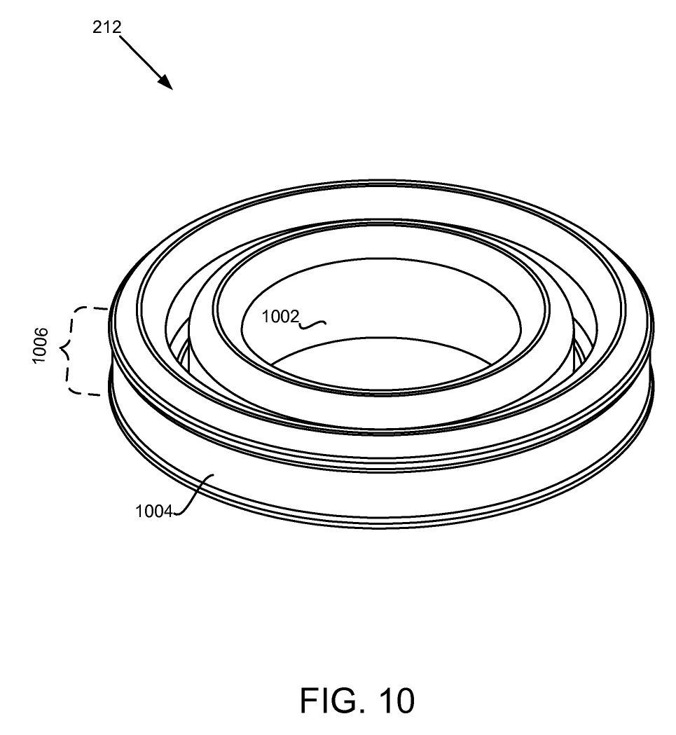

FIG. 10 is a perspective view diagram illustrating one embodiment of the gravel guard 212. The gravel guard 212 has a neck portion 1002 with a first diameter and base portion 1004 with a second diameter. The base portion 1004 mounts to the mounting area of the collar of the first flange 206 of FIG. 4. The base portion includes a banding area operably configured to receive a band clamp (not shown), which secures the gravel guard 212 onto the first flange 206. Alternatively, the gravel guard 212 may be installed without a band clamp.

The base portion 1004 includes a height 1006. In one embodiment, the height 1006 of the base portion 1004 is in the range of between about 0.5 and 3 inches. However, it should be appreciated that in other various exemplary embodiments, the values for the height and the diameter may be adjusted according to the user's needs.

The gravel guard 212, in one embodiment, is in an accordion shape to allow the gravel guard 212 to be flexible and connect the base portion 1004 to the first flange 206. The neck portion 1002 is positioned such that when in use, the neck portion 1002 extends in towards the first flange 206 instead of away as with conventional boots, for example the second flexible boot 222.

The neck portion 1002 extending in towards the first flange 206 allows the gravel guard 212 to seal against the pipe, when the pipe is inserted into the fitting 200, as shown in FIG. 2.

The advantage of the present disclosure is that the pipe may be removed from the tank without having to excavate the dirt external to the tank, especially when a band clamp is not used on the gravel guard. A worker can, from the inside of the tank, remove the band clamp around the first and second boots 220, 222 and slide the pipe out of the fitting 200. Subsequently, when the worker replaces the pipe, the worker can also replace the first and second boots 220, 222 from inside the underground storage tank. In other words, the present disclosure beneficially enables maintenance of the fitting 200 without the costly expense of excavating around the pipe because the first and second boots 220, 222, and the mounting hardware is replaceable from the inside of the underground storage tank.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus for sealing a tube that extends through a double wall, the apparatus: comprising:
a first annular gasket disposed between a first flange and an outer wall of a double wall, the first annular gasket formed to engage both the outer wall and the first flange;
wherein the first flange comprises a sleeve extending through the first annular gasket, an opening in the double wall, a second annular gasket, and a second flange; and
wherein the second annular gasket is disposed between an inner wall of the double wall and the second flange, the second annular gasket formed to engage both the inner wall and the second flange.

2. The apparatus of claim 1, wherein the first flange further comprises a first boot mounting portion formed to engage a first flexible sealing boot having a diameter selected to form a seal between the sleeve and a tube extending through the first flange and the second flange.

3. The apparatus of claim 2, wherein the second flange further comprises a collar extending away from the double wall and having a second boot mounting portion, the second boot mounting portion formed to engage a second flexible sealing boot having a diameter selected to form a seal with the tube and enclose the second annular gasket and the second flange.

4. The apparatus of claim 3, wherein the first flexible sealing boot and the second flexible sealing boot each comprise an interlocking portion such that the first flexible sealing boot and the second flexible sealing boot are secured to the tube with a single fastening device.

5. The apparatus of claim 1, wherein the first flange further comprises a plurality of mounting devices positioned radially outside of the sleeve and extending through the first and second annular gaskets and into corresponding openings in the second flange.

6. The apparatus of claim 5, wherein the plurality of mounting devices further comprises a plurality of threaded rods extending through the second flange, and wherein the second flange further comprises a plurality of fasteners, each of the plurality of fasteners corresponding to one of the plurality of threaded rods such that the second flange securely fastens to the first flange.

7. The apparatus of claim 1, wherein the first flange further comprises a collar extending away from the double wall and having a boot mounting portion.

8. The apparatus of claim 7, further comprising a gravel guard having a first end coupled with the collar of the first flange, and a second end having a diameter selected to engage a tube extending through the first flange.

9. An apparatus for sealing a tube that extends through a double wall, the apparatus comprising:
a first annular gasket disposed between a first flange and an outer wall of a double wall, the first annular gasket having an inner sealing surface formed to engage the outer wall and an outer sealing surface formed to engage the first flange;
wherein the first flange comprises a sleeve extending from the first flange and having a diameter less than a diameter of the first annular gasket such that the sleeve extends through the first annular gasket and through an opening in the double wall, the first flange further comprising mounting devices extending through the opening;
wherein the sleeve further comprises a first boot mounting area formed at the distal end of the sleeve;
a second annular gasket disposed between an inner wall of the double wall and a second flange, the second annular gasket having an inner surface formed to engage the inner wall, and an outer surface formed to engage the second flange; and
a second flange comprising openings for receiving the mounting devices and a collar extending away from the inner wall and having a second boot mounting end formed at the distal end of the collar.

10. The apparatus of claim 9, wherein the first boot mounting portion is formed to engage a first flexible sealing boot having a diameter selected to form a seal between the sleeve and a tube extending through the first flange and the second flange.

11. The apparatus of claim 10, wherein the second boot mounting portion is formed to engage a second flexible sealing boot having a diameter selected to form a seal with the tube and enclose the second annular gasket and the second flange.

12. The apparatus of claim 11, wherein the first flexible sealing boot and the second flexible sealing boot each comprise an interlocking portion such that the first flexible sealing boot and the second flexible sealing boot are secured to the tube with a single fastening device.

13. The apparatus of claim 9, wherein the mounting devices further comprise a plurality of threaded rods extending through the second flange, and wherein the second flange further comprises a plurality of fasteners, each of the plurality of fasteners corresponding to one of the plurality of threaded rods such that the second flange securely fastens to the first flange.

14. The apparatus of claim 9, wherein the first flange further comprises a collar extending away from the double wall and having a boot mounting portion.

15. The apparatus of claim 14, further comprising a gravel guard having a first end coupled with the collar of the first flange, and a second end having a diameter selected to engage a tube extending through the first flange.

16. An apparatus for sealing a tube that extends through a double wall, the apparatus comprising:
a first flexible sealing boot having first and second ends, the first end having a diameter selected to engage a tube that extends through the first flexible sealing boot, and the second end having a diameter selected to couple with a boot mounting portion of a first flange;
a second flexible sealing boot having first and second ends, the first end having an interlocking portion that engages the first end of the first flexible sealing boot, and a second end having a diameter selected to couple with a second flange; and
wherein the second flexible sealing boot has a length selected to enclose the first flexible sealing boot, the first flange, the second flange, and a plurality of mounting devices extending from the first flange to the second flange.

17. The apparatus of claim 16, wherein the first flange further comprises a sleeve extending from the first flange through an opening in a double wall and through an opening in the second flange.

18. The apparatus of claim 16, further comprising an annular gasket disposed between the first flange and an outer wall, the annular gasket formed to engage both the outer wall and the first flange.

19. The apparatus of claim 18, wherein the annular gasket is formed to engage a curved outer wall.

20. The apparatus of claim 18, wherein the annular gasket is formed to engage a planar outer wall.
